(19) United States
(12) Patent Application Publication
(10) Pub. No.: US 2009/0038165 A1
(43) Pub. Date: Feb. 12, 2009

(54) Cutting Apparatus

(76) Inventor: Chien-Hsun Lai, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/834,880

(22) Filed: Aug. 7, 2007

(51) Int. Cl. B26B 29/06

(52) U.S. Cl. 30/287; 30/293

(57) ABSTRACT

A cutting apparatus includes a blade, a jaw pivotally connected to the blade, an anvil secured to the jaw, an angle-adjusting element pivotally connected to the anvil and at least one positioning device provided on the indicator. The anvil includes marks for indicating different angles at which a piece of work is to be cut by the blade and cutouts in the edge corresponding to the marks. The angle-adjusting element includes at least one indicator for pointing at one of the marks of the anvil. The positioning device is movable between a locking position in a selected one of the cutouts for locking the angle-adjusting element to the anvil and an unlocking position away from the cutouts for allowing the pivoting of the angle-adjusting element on the anvil.

### BACKGROUND OF INVENTION

1. Field of Invention

The present invention relates to a cutting apparatus and, more particularly, to a cutting apparatus with an angle adjustor.

2. Related Prior Art

Disclosed in Taiwanese Patent Publication No. 595534 is a cutting apparatus including a blade 12, a jaw 11 pivotally connected to the blade 12, an anvil 20 provided on the jaw 11 and an angle-adjusting element 30 pivotally connected to the anvil 20. The anvil 20 includes marks 23 provided thereon for marking angles at which a piece is to be cut and recesses 24 corresponding to the marks 23. The angle-adjusting element 30 includes two indicators 31 located above the anvil 20. Each of the indicators 31 includes an aperture and a screw hole 32 in communication with the aperture. A ball 33 and a spring 34 are disposed in the screw hole 32 of each of the indicators 31. Threaded bolts 35 are driven in the screw holes 32. The size of the apertures is smaller than that of the screw holes 32 so that the balls 33 can be partially exposed from the related aperture, but not released from the screw hole 32. The balls 33 can be disposed in two of the recesses 24 to indicate a selected one of the angles. The balls 33 are retained in the recesses 24 by the springs 34, thus positioning the angle-adjusting element 30 on the anvil 20. The springs 34 might not be enough to firmly position the angle-adjusting element 30 on the anvil 20. The angle-adjusting element 30 could easily be moved by mistake. In addition, when a heavy load is exerted on the angle-adjusting element 30 by a piece of work, the angle-adjusting element 30 might be moved on the anvil 20. Moreover, the balls 33 will be worn against the anvil 20 so that the balls 33 will become smaller while the recesses 24 will become larger. Hence, the angle-adjusting element 30 cannot be precisely positioned on the anvil 20.

The present invention is therefore intended to obviate or at least alleviate the problems encountered in prior art.

### SUMMARY OF INVENTION

According to the present invention, a cutting apparatus includes a blade, a jaw pivotally connected to the blade, an anvil secured to the jaw, an angle-adjusting element pivotally connected to the anvil and at least one positioning device provided on the indicator. The anvil includes marks for indicating angles at which a piece of work is to be cut by the blade and cutouts in the edge corresponding to the marks. The angle-adjusting element includes at least one indicator for pointing at one of the marks of the anvil. The positioning device is movable between a locking position in a selected one of the cutouts for locking the angle-adjusting element to the anvil and an unlocking position away from the cutouts for allowing the pivoting of the angle-adjusting element on the anvil.

An advantage of the cutting apparatus according to the present invention is that the positioning of the angle-adjusting element on the anvil is firm since the insertion of the positioning device in a selected one of the cutouts is firm.

Another advantage of the cutting apparatus according to the present invention, the positioning of the angle-adjusting element on the anvil is always precise since the position device away from the anvil in the unlocking position so that the do not wear against each other.

Another advantage of the cutting apparatus according to the present invention is a low cost for including simple parts that can easily be assembled.

Other objectives, advantages and features of the present invention will become apparent from the following description referring to the attached drawings.

### BRIEF DESCRIPTION OF DRAWINGS

The present invention will be described via detailed illustration of two embodiments referring to the drawings.

FIG. 1 is a perspective view of a cutting apparatus according to the first embodiment of the present invention.

FIG. 2 is an exploded view of the cutting apparatus shown in FIG. 1.

FIG. 3 is a top view of the cutting apparatus shown in FIG. 1.

FIG. 4 is a side view of the cutting apparatus shown in FIG. 1.

FIG. 5 is a cross-sectional view of the cutting apparatus taken along a line 5-5 in FIG. 4.

FIG. 6 is a cross-sectional view of the cutting apparatus taken along a line 6-6 in FIG. 5.

FIG. 7 is a cross-sectional view of the cutting apparatus in another position than shown in FIG. 5.

FIG. 8 is a cross-sectional view of the cutting apparatus taken along a line 8-8 in FIG. 7.

FIG. 9 is a top view of the cutting apparatus in another position than shown in FIG. 3.

FIG. 10 is a perspective view of a cutting apparatus according to the second embodiment of the present invention.

FIG. 11 is a side view of the cutting apparatus shown in FIG. 10.

### DETAILED DESCRIPTION OF EMBODIMENTS

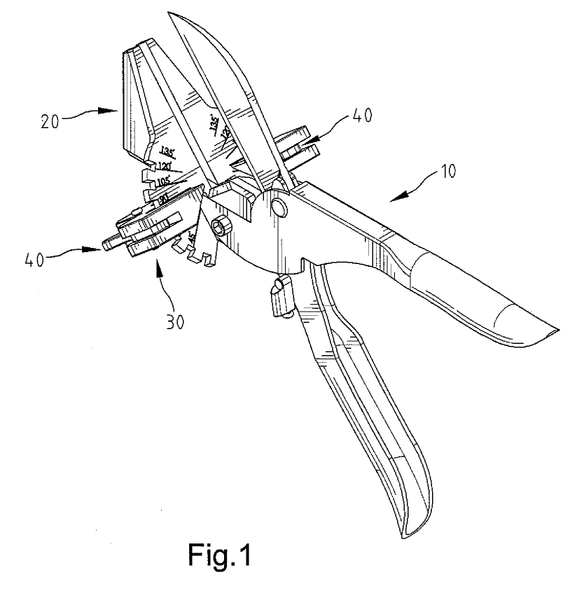

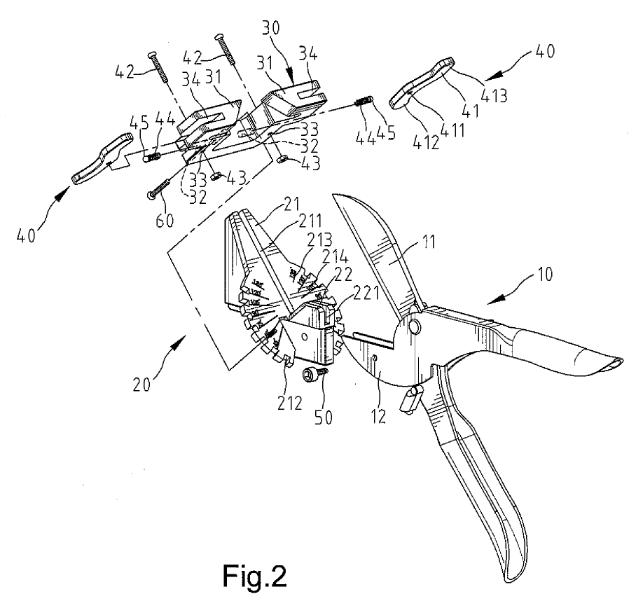

Referring to FIGS. 1 and 2, a cutting apparatus includes a blade 11, a jaw 12 pivotally connected to the blade 1 1, an anvil 20 secured to the jaw 12, an angle-adjusting element 30 pivotally connected to the anvil 20 and two positioning devices 40 for positioning the angle-adjusting element 30 on the anvil 20.

The anvil 20 includes a first portion 21 and a second portion 22 formed on an upper side of the first portion 21. A groove 211 is defined in the middle of the first portion 21 of the anvil 20. The groove 211 is used to receive the blade 11. A group of cutouts 212 is defined in the edge of the anvil 20 on one side of the groove 211. Another group of cutouts 212 is defined in the anvil 20 on another side of the groove 212. Two groups of marks 213 are provided on the anvil 20 so that each of the marks 213 is located near a related one of the cutouts 212. Each of the marks 213 is used to indicate an angle. Two groups of numbers 214 are provided on the anvil 20 so that each of the numbers 214 is located near a related one of the marks 213. Each of the numbers 214 is used to indicate the reading of an angle. A groove 221 is defined in the middle of the second portion 22 of the anvil 20. There is an angle of about 135 degrees between the length of the groove 221 and the length of the groove 211. The second portion 22 of the anvil 20 is connected to the jaw 12 by a fastener 50 so that the anvil 20 is secured to the jaw 12. The jaw 12 is located on the upper side of the first portion 21 of the anvil 20.

The angle-adjusting element 30 includes two indicators 31. Each of the indicators 31 includes a cavity 32 defined therein, an aperture 33 defined therein and a slit 34 defined therein. The cavities 32 are directed opposite to each other. The apertures 33 are defined parallel to each other. The slits 34 are directed opposite to each other. The angle-adjusting element 30 is pivotally connected to the anvil 20 by a threaded bolt 60 so that each of the indicators 31 is movable on a related one of the groups of marks 213.

Each of the positioning devices 40 includes a positioning element 41, a threaded bolt 42, a nut 43, an elastic element 44 and a ball 45. The positioning element 41 includes an aperture 411 defined therein, a first portion 412 and a second portion 413. The elastic element 44 and the ball 45 are disposed in the cavity 32 of each of the indicators 31. The first portion 412 of the positioning element 41 is disposed in the slit 34 of each of the indicators 3 1. The threaded bolt 42 is inserted through the aperture 33 of each of the indicators 31 and the aperture 411 and engaged with the nut 43 so that the positioning element 41 is pivotally connected to each of the indicators 31. The first portion 412 of the positioning element 41 is in contact with the ball 45 and hence biased by the elastic element 44 so that it tends to move away from the first portion 412 of the other positioning element 41. That is, the second portion 413 of the positioning element 41 tends to move towards the second portion 413 of the other positioning element 41.

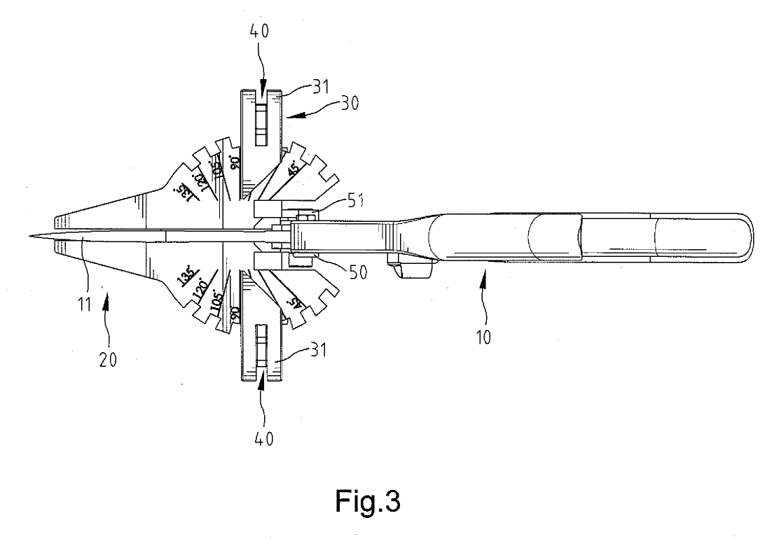

Referring to FIG. 3, each of the indicators 31 includes an indicating side located very close to one of the marks 213 of a related one of the groups. The indicating sides of the indicators 31 are located in a same line. Thus, each of the indicators 31 indicates an angle at which a piece of work is to be cut by the blade 11. The piece of work is located against the indicating sides of the indictors 31 on the first portion 21 of the anvil 20.

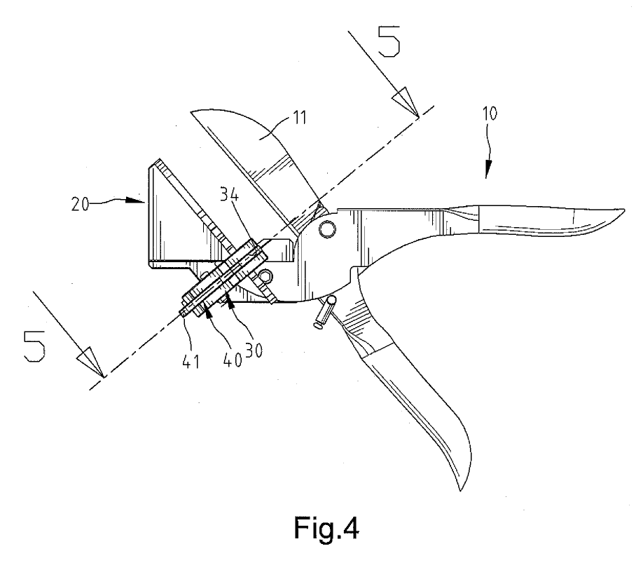

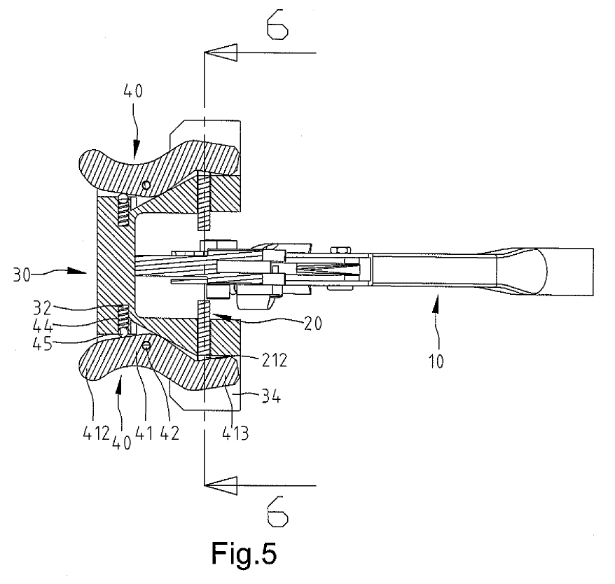

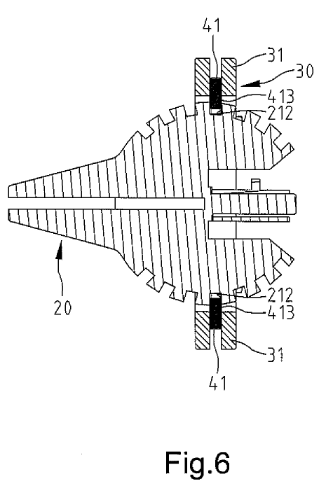

Referring to FIGS. 4 through 6, the second portion 413 of each of the positioning elements 41 is retained in one of the cutouts 212 of a related one of the groups because the first portion 412 of the same is biased by a related one of the elastic elements 44. Since the insertion of the second portions 413 of the positioning elements 41 in the cutouts 212 is firm, the positioning of the angle-adjusting element 30 on the anvil 20 is firm.

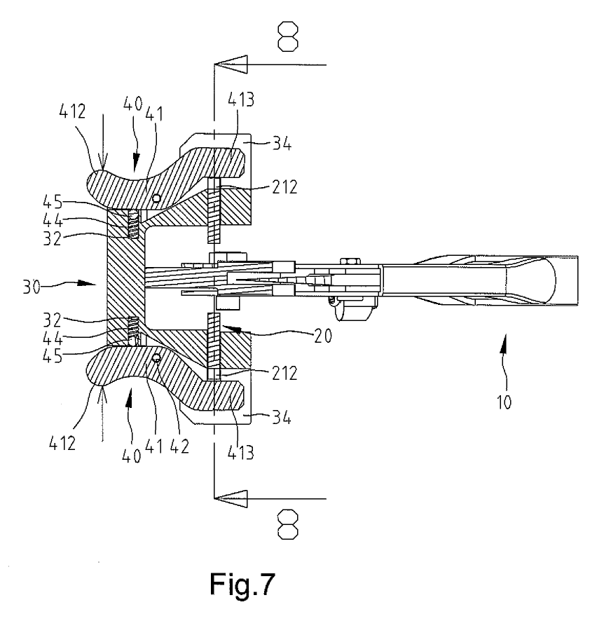

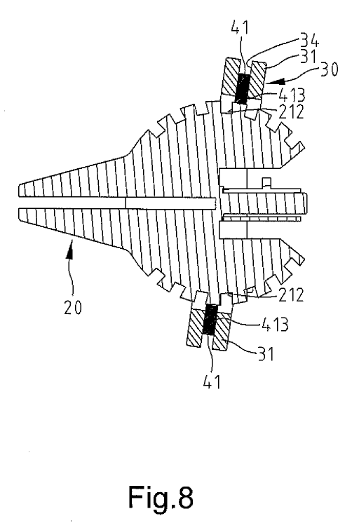

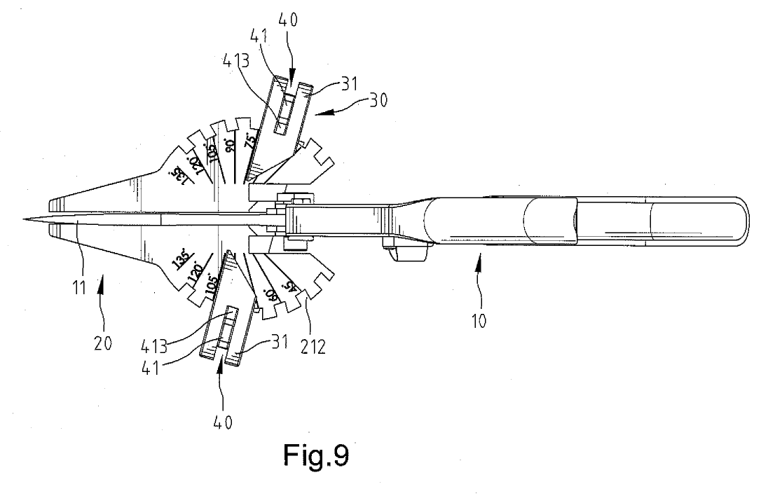

Referring to FIGS. 7 through 9, a user can move the first portions 412 of the positioning elements 41 towards each other to move the second portions 413 of the positioning elements 41 from the cutouts 212. The user can then pivot the angle-adjusting element 30 on the anvil 20 to select an angle at which a piece of work is to be cut. During the pivoting of the angle-adjusting element 30 on the anvil 20, the second portions 413 of the positioning elements 41 are retained from the anvil 20 so that the second portions 413 of the positioning elements 41 do not wear against the anvil 20.

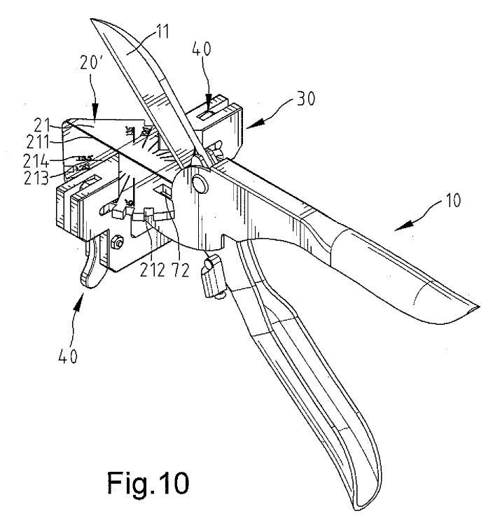

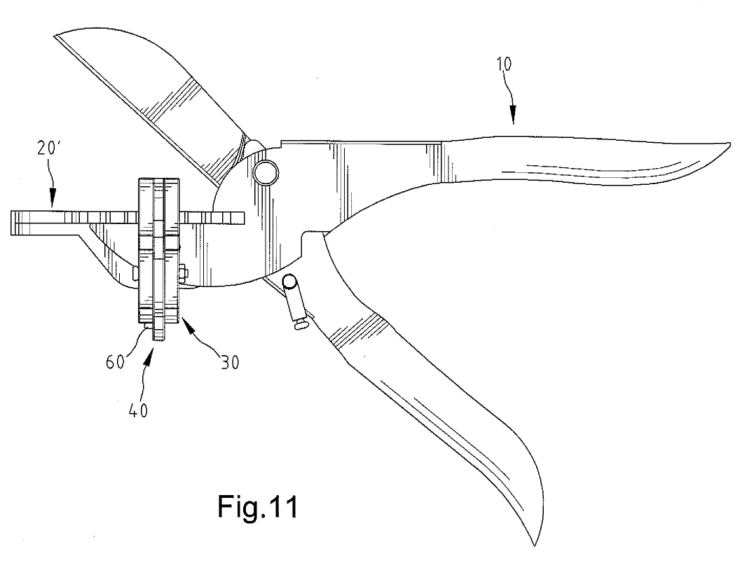

Referring to FIGS. 10 and 11, there is shown a cutting apparatus according to a second embodiment of the present invention. The second embodiment is like the first embodiment except including an anvil 20′ instead of the anvil 20. The anvil 20′ is like the anvil 20 except including a second portion located on a lower side of the first portion 21 thereof. The jaw 12 is connected to the second portion of the anvil so that the jaw 12 is located beneath the first portion 21 of the anvil 20. The upper side of the first portion 21 of the anvil 20 is parallel to the length of the jaw 12.

The cutting apparatus according to the present invention exhibits several advantages as follows:

Firstly, the positioning of the angle-adjusting element 30 on the anvil 20 is firm since the elastic elements 44 bias the first portions 412 of the positioning elements 41 and firmly retain the second portions 413 of the positioning elements 41 in the cutouts 212.

Secondly, the positioning of the angle-adjusting element 30 on the anvil 20 is always precise since the second portions 413 of the positioning elements 41 will not become smaller and the cutouts 212 will not become larger after some time of use. This is because the second portions 413 of the positioning elements 41 are retained from the anvil 20 so that the second portions 413 of the positioning elements 41 do not wear against the anvil 20 during the pivoting of the angle-adjusting element 30 on the anvil 20.

Thirdly, it can be produced at a low cost for including simple parts that can easily be assembled.

The present invention has been described via the detailed illustration of the embodiments. Those skilled in the art can derive variations from the embodiments without departing from the scope of the present invention. Therefore,.the embodiments shall not limit the scope of the present invention defined in the claims.

1. A cutting apparatus comprising:
a blade;
a jaw pivotally connected to the blade;
an anvil being secured to the jaw and comprising marks for indicating different angles at which a piece of work is to be cut by the blade and cutouts in the edge corresponding to the marks;
an angle-adjusting element being pivotally connected to the anvil and comprising at least one indicator for pointing at one of the marks of the anvil; and
at least one positioning device provided on the indicator and movable between a locking position in a selected one of the cutouts for locking the angle-adjusting element to the anvil and an unlocking position away from the cutouts for allowing the pivoting of the angle-adjusting element on the anvil.

2. The cutting apparatus according to claim 1 wherein the anvil comprises numbers on the anvil corresponding to the marks.

3. The cutting apparatus according to claim 1 wherein the positioning device comprises a positioning element pivotally connected to the indicator and movable into a selected one of the cutouts for locking the angle-adjusting element to a selected one of the readings of the angle.

4. The cutting apparatus according to claim 1 wherein the indicator comprises an aperture defined t herein, the positioning element comprises an aperture defined therein, and the positioning device comprising a fastener driven through the apertures of the indicator and the aperture of the positioning element.

5. The cutting apparatus according to claim 4 wherein fastener is a threaded bolt engaged with a nut.

6. The cutting apparatus according to claim 3 wherein the positioning device comprises an elastic element compressed between the indicator and the positioning element.

7. The cutting apparatus according to claim 6 wherein the positioning device comprises a ball connected to the elastic element one hand and in contact with the positioning element on the other hand.

8. The cutting apparatus according to claim 7 wherein the indicator comprises a cavity for receiving the elastic element.

9. The cutting apparatus according to claim 8 wherein positioning element comprises a first portion in contact with the ball and a second portion for insertion in a selected one of the cutouts.

10. The cutting apparatus according to claim 1 wherein the indicator comprises a slit defined therein for receiving the positioning device.

11. The cutting apparatus according to claim 1 wherein the anvil comprises a first portion on which the marks are provided and a second portion formed on the first portion and secured to the jaw.

12. The cutting apparatus according to claim 11 wherein the first portion of the anvil comprises a groove defined therein, and the second portion of the anvil comprises a groove defined therein so that there is an angle of about 135 degrees between the lengths of the grooves.

13. The cutting apparatus according to claim 1 wherein the anvil comprises two groups of marks and two groups of cutouts, the angle-adjusting element comprises two indicators each for cooperation with a related one of the groups of marks, and the cutting apparatus comprises two positioning devices each for insertion in a related one of the groups of cutouts.

14. The cutting apparatus according to claim 13 wherein each of the positioning devices comprises a positioning element pivotally connected to a related one of the indicators.

15. The cutting apparatus according to claim 14 wherein each of the indicators comprises a slit for receiving a related one of the positioning elements.
